(19) United States
(12) Patent Application Publication
(10) Pub. No.: US 2013/0246184 A1
(43) Pub. Date: Sep. 19, 2013

(54) METHOD AND SYSTEM FOR DISPLAYING A CONTEXTUAL ADVERTISEMENT ON A WEBPAGE

(71) Applicants: Kevin Flood, Manchester (GB); Michael Harty, Flintshire (GB); Michael Duma, Nottingham (GB)

(72) Inventors: Kevin Flood, Manchester (GB); Michael Harty, Flintshire (GB); Michael Duma, Nottingham (GB)

(73) Assignee: PowerLinks Media Limited, Manchester (GB)

(21) Appl. No.: 13/418,715

(22) Filed: Mar. 13, 2012

(51) Int. Cl. G06Q 30/02

(52) U.S. Cl. 705/14.66; 705/14.49

(57) ABSTRACT

A method for displaying an advertisement includes storing, in a database, a plurality of keywords wherein each keyword in the plurality of keywords corresponds to a product or service, assigning a priority value to each keyword in the plurality of keywords, analyzing a webpage to identify a plurality of words displayed by the webpage. selecting a word in the plurality of words based on the assigned weight value, comparing the selected word to the plurality of keywords to obtain at least one matched keyword, selecting at least one keyword from the at least one matched keyword based on the assigned priority value, and modifying the webpage such that when a user of the webpage interacts with the selected word displayed by the webpage, an advertisement for the product or service corresponding to the at least one keyword is displayed.

### FIELD

The present disclosure relates to embedding of contextually-relevant advertisements in a webpage, specifically to modifying an existing webpage to provide relevant advertisements when hovering a mouse or touch point over specific keywords.

### BACKGROUND

Online advertising has become a prolific field with a variety of methods designed to capitalize on the large amounts of web traffic. As a result, online advertising has evolved in the direction of turning what were once generic and often times misplaced advertisements into advertisements that are more relevant to the user and the context of the webpage itself.

Traditional online advertising was in the form of banner or pop-up advertisements. These types of advertisements could be easily overlooked or ignored by the visitor of the webpage, making them less effective. Traditional advertising was also largely inefficient, with a website displaying a generic banner to all visitors to the website, regardless of differences in demographics or the actual page on the website being viewed at the time, and thus not always reaching the advertiser's target market. Traditional advertisements have also been hard-coded into the webpage on which they are placed. Hard-coded advertisements can go out of date, the accompany hyperlinks can become broken, and may often times require an advertising partnership to be formed prior to the generation of revenue.

Banner and pop-up advertisements have also begun to lose favor in a society where more and more consumers are using mobile devices for web browsing. A browser on a cell phone, smart phone, or tablet computer may show a zoomed in version of a webpage in order to present more readable text to the user, which can effectively prohibit exposure of banner or pop-up advertisements. In some instances, browsers, both mobile and traditional, may even be configured to remove such advertisements from display entirely.

More modern trends in online advertising have included placing ads within the text of the webpage itself, where the user directs the majority of their attention. Some forms of advertising include physically replacing words with product or service names, while others include transforming words into hyperlinks that may link the user to a product or service. However, such methods continue to lack in efficiency. Traditional systems and methods will often times display a generic advertisement that is not properly suited to the viewer's interests, an ill-placed advertisement that does not properly reach the viewer, or may be hardcoded in a webpage in such a way as to make modifying the advertisement difficult, costly, and inconvenient. What is needed is a more efficient method or system for providing an advertisement on a webpage that is based on multiple considerations, including the value of the advertising keyword, the value of the words on the webpage, and the value of the advertisements themselves. That is, there are technological challenges to effectively identify when and how advertisements should be presented to a user.

### SUMMARY

The present disclosure provides a description of a technical solution to the problem of more efficiently delivering appropriate content to a user without significant human intervention. Exemplary methods and systems for the distribution or display of advertisements on a webpage or other document having the capability being linked to other content (hereinafter collectively referred to as a “webpage”) are disclosed.

A method for displaying an advertisement includes storing, in a keyword database, a plurality of keywords wherein each keyword in the plurality of keywords corresponds to a product or service, assigning a priority value to each keyword in the plurality of keywords, and analyzing a webpage to identify a plurality of words displayed by the webpage. The method also includes assigning a weight value to each word in the plurality of words, selecting a word in the plurality of words based on the assigned weight value, and comparing the selected word to the plurality of keywords to obtain at least one matched keyword. The method further includes selecting at least one keyword from the at least one matched keyword based on the assigned priority value and modifying the webpage such that when a user of the webpage interacts with the selected word displayed by the webpage, an advertisement for the product or service corresponding to the at least one keyword is displayed.

A system for displaying an advertisement includes a database configured to store a plurality of keywords wherein each keyword in the plurality of keywords corresponds to a product or service. The system also includes a processor configured to: assign a priority value to each keyword in the plurality of keywords, analyze a webpage to identify a plurality of words displayed by the webpage, assign a weight value to each word in the plurality of words, select a word in the plurality of words based on the assigned weight value, and compare the selected word to the plurality of keywords to obtain at least one matched keyword. The processor is further configured to select at least one keyword from the at least one matched keyword based on the assigned priority value and modify the webpage such that when a user of the webpage interacts with the selected word displayed by the webpage, an advertisement for the product or service corresponding to the at least one keyword is displayed.

A method for distributing advertisements includes storing, in a database, a plurality of keywords, receiving product data corresponding to a plurality of goods and services from a plurality of advertisers, normalizing, by a computer, the received product data such that the product data is formatted into a single layout, and assigning a priority value to each good and service of the plurality of goods and services. The method also includes corresponding each good and service of the plurality of goods and services to at least one keyword of the plurality of keywords, associating, in the database, the product data corresponding to each good and service of the plurality of goods and services to the corresponding at least one keyword, and receiving a request for an advertisement for a specified keyword of the plurality of keywords. The method further includes selecting at least one specified good or service based on the priority value of each good or service corresponding to the specified keyword, and transmitting a reply to the request for an advertisement wherein the reply includes the product data corresponding to the at least one specified good or service.

A system for distributing advertisements includes a database configured to store a plurality of keywords, a receiving device configured to receive product data corresponding to a plurality of goods and services from a plurality of advertisers, and a processor. The processor is configured to normalize the received product data such that the product data is formatted into a single layout, assign a priority value to each good and service of the plurality of goods and services, correspond each good and service of the plurality of goods and services to at least one keyword of the plurality of keywords, associate, in the database, the product data corresponding to each good and service of the plurality of goods and services to the corresponding at least one keyword, receive a request for an advertisement for a specified keyword of the plurality of keywords, and select at least one specified good or service based on the priority value of each good or service corresponding to the specified keyword. The system further includes a transmitting device configured to transmit a reply to the request for an advertisement wherein the reply includes the product data corresponding to the at least one specified good or service.

### BRIEF DESCRIPTION OF THE DRAWING FIGURES

Exemplary embodiments are best understood from the following detailed description when read in conjunction with the accompanying drawings. It is emphasized that the invention recited in the accompanying claims is not limited to these particular exemplary embodiments. Included in the drawings are the following figures:

FIG. 1 is a block diagram illustrating a system for displaying advertisements on a webpage in accordance with exemplary embodiments.

FIG. 2 is a block diagram illustrating a processing server in accordance with exemplary embodiments.

FIG. 3 is a flow chart illustrating a method for distributing advertisements to a webpage in accordance with exemplary embodiments.

FIG. 4 is a flow chart illustrating analyzing a webpage for the display of an advertisement in accordance with exemplary embodiments.

FIG. 5 is an illustrating of a graphical user interface of an advertisement displayed by the system of FIG. 1 in accordance with exemplary embodiments.

FIG. 6 is a flow chart illustrating an exemplary method for displaying an advertisement in accordance with exemplary embodiments.

FIG. 7 is a flow chart illustrating an exemplary method for distributing advertisements in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Overview of a System for Displaying Advertisements

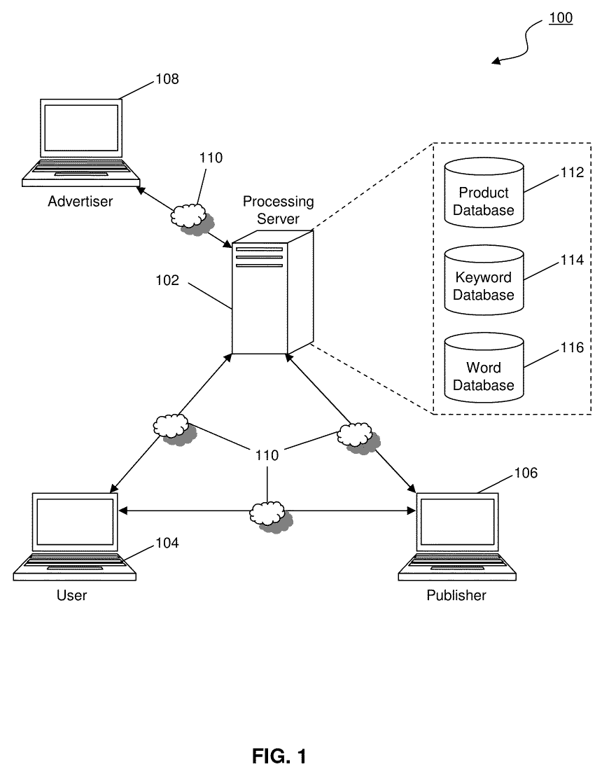

FIG. 1 illustrates a system 100 for displaying advertisements on a webpage. The system 100 may include a processing server 102, a user 104, a publisher 106, and an advertiser 108, each of which may be connected to and/or communicate via a network 110. The network 110 may be of any wired or wireless type of network including a local area network (LAN), wide area network (WAN), WiFi, the Internet, coaxial cable, fiber optic, radio frequency, infrared, combinations thereof, or any other suitable configuration as will be apparent to persons having skill in the relevant art.

The user 104 may access a webpage published by the publisher 106 (e.g., or a web server on behalf of the publisher). The user 104 may use any traditional browsing device (e.g., a personal computer, smart phone, tablet computer, etc.) as will be apparent to persons having skill in the relevant art. The webpage may display a plurality of words. The processing server 102 may be configured to analyze the webpage to identify the plurality of words, and may store the plurality of words in a word database 116. Here, it should be understood that “word” or “words” can include a phrase or specified sequence within a range of words (e.g., a phrase with interspersed non-key words). The processing server 102 and its functions are discussed in more detail below.

The processing server 102 may also be configured to generate a plurality of keywords (e.g., from words identified from a plurality of analyzed webpages), which may be stored in a keyword database 114. The advertiser 108 may transmit (e.g., via the network 110) product data for a plurality of goods and services to the processing server 102, which may store the product data in a product database 112. The advertiser 108 may be a merchant, a retailer, a service provider, or any other entity that may provide advertising content for display on a webpage. The processing server 102 may standardize the received product data, and may associate the received product data with at least one keyword stored in the keyword database 114. As discussed in more detail below, the processing server 102 may select at least one word from the plurality of words (e.g., based on a weight value), match the at least one word with a keyword (e.g., based on a priority value), and integrate the at least one word in the displayed webpage with a user interaction to display an advertisement associated with a good or service corresponding to product data associated to the matched keyword.

The publisher 106 (or, e.g., a web server on behalf of the publisher 106) may display the webpage to the user 104, with the user interaction integrated with the at least one word. The user 104 may interact with the word and be presented with an advertisement directed to the associated good or service.

### The Processing Server

The processing server 102 may be any type of server suitable for performing the functions as discussed herein. The processing server 102 may be a personal computer or a plurality of personal computers. The processing server 102 may additionally or alternatively be a server computer, a plurality of server computers interfaced together (e.g., physically, or via a network such as the network 110), or a combination of server computers and personal computers. Other devices suitable as the processing server 102 will be apparent to persons having skill in the relevant art.

The processing server 102 may include the product database 112, the keyword database 114, and the word database 116. Each of the three databases may be internal to the processing server 102 or may be external to the processing server 102 and accessed via a network (e.g., the network 110), or a combination thereof. Each database may store data on any type of suitable computer readable media, such as optical storage (e.g., a compact disc, digital versatile disc, blu-ray disc, etc.) or magnetic tape storage (e.g., a hard disk drive). Each of the databases may be configured in any type of suitable database configuration, such as a relational database, a structured query language (SQL) database, a distributed database, an object database, etc. Suitable configurations and storage types of the databases will be apparent to persons having skill in the relevant art. In some embodiments, each database may be configured as multiple databases which may be interfaced together (e.g., via the network 110). In other embodiments, the product database 112, the keyword database 114, and the word database 116 may comprise a single database.

The product database 112 may store product data for a plurality of products (e.g., goods and services), as discussed in more detail below. The keyword database 114 may store a plurality of keywords. A keyword may be any word or words within a given or variable range, phrase as will be apparent to persons having skill in the relevant art. Each keyword in the plurality of keywords may be assigned a weight value, which may also be stored in the database 114, as discussed in more detail below. The word database 116 may store a plurality of words identified by analyzing a webpage, discussed in further detail below.

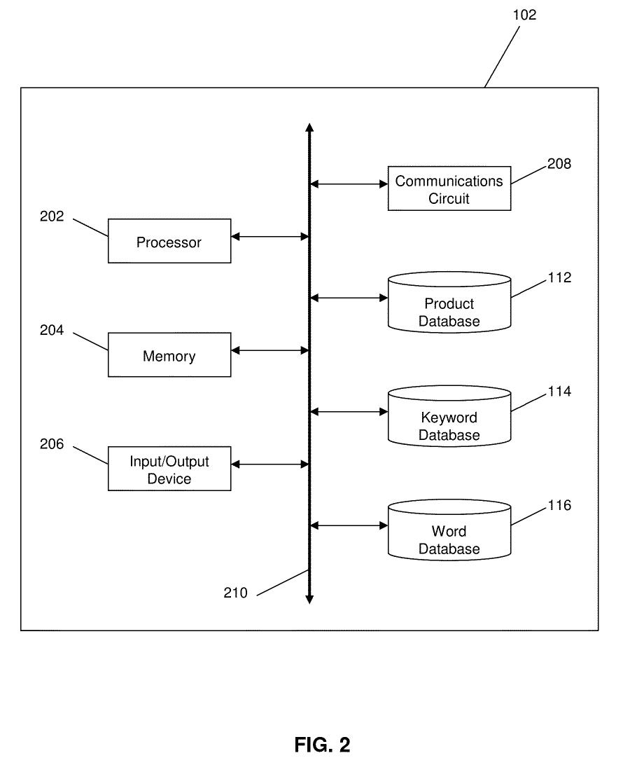

FIG. 2 illustrates a block diagram of an exemplary processing server 102. Components of the processing server 102 may be connected via a bus 210, as will be apparent to persons having skill in the relevant art. The processing server 102 may include a processor 202 (e.g., a central processing unit) that may be configured to perform the functions as disclosed herein. The processor 202 may execute a program that may be stored on a memory 204. The memory 204 may be a read-only memory (ROM), a random access memory (RAM), or any other suitable type of memory as will be apparent to persons having skill in the relevant art.

The processing server 102 may also include an input/output (I/O) device 206. The I/O device 206 may be configured to transmit or receive data to or from the processing server 102. For example, the I/O device 206 may be configured to receive product data from the advertiser 108 or transmit a user interaction to the publisher 106. The I/O device 206 may transmit or receive data by going through a communications circuit 208. The communications circuit 208 may be any circuit configured to process, transmit, or receive data through a network (e.g., the network 110). Suitable circuit schematics will be apparent to persons having skill in the relevant art.

### Method for Distributing Advertisements

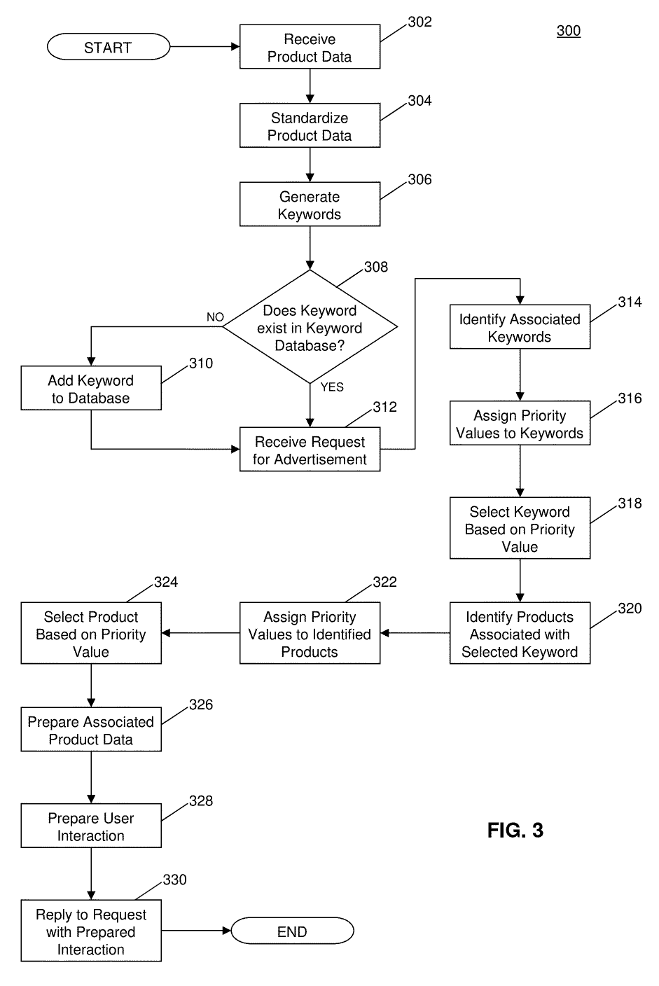

FIG. 3 illustrates a method of efficiently distributing an advertisement to a webpage for presentation during a user interaction using the system 100 including the processing server 102. In conjunction with the above-described architecture, a general purpose computer becomes a specific purpose computer carrying out the algorithm set forth by way of the exemplary series of method steps.

In step 302, a processing server (e.g., the processing server 102) receives product data (e.g., from the advertiser 108). Product data may include information on a plurality of goods and services (e.g., offered by the advertiser, such as for a merchant). Exemplary product data may include product name, retail price, quantity, merchant name, merchant information, purchase address (e.g., a web address where the user may purchase the product), description, brand name, color, universal product code (UPC), manufacturer part number (MPN), European article number (EAN), international standard book number (ISBN), size, specifications, or any other suitable information as will be apparent to persons having skill in the relevant art. In some embodiments, the product data may include a plurality of merchant names or a plurality of purchase addresses. The processing server 102 may store the product data in a database (e.g., the product database 112).

In step 304, the processing server 102 may standardize the product data. Standardizing the data may include formatting all of the product data into a single layout following a standard set of values and logics. This is one aspect of the technical solution presented. Methods of standardizing data will be apparent to persons having skill in the relevant art. The standardization of data may lead to more complete advertisements as well as provide a faster, more efficient method of distributing and displaying product data.

In step 306, the processing server 102 may go through each product (e.g., good or service) in the received product data (e.g., and stored in the product database 112) and generate and allocate keywords to the product. Keywords may be generated and allocated to the product based on the associated product data (e.g., product name, product brand, product type, product description, merchant name, etc.). For example, an iPhone® made by Apple® may have the keywords phone, smartphone, cell phone, handheld, Apple®, iPhone®, iTunes®, music player, mp3, camera, camcorder, GPS unit, etc. allocated to the product. Allocations of keywords may be stored in the keyword database 114, or may be stored in the product database 112, or a combination thereof.

In step 308, the processing server 102 may go through each keyword generated and determine if a keyword exists in a keyword database (e.g., the keyword database 114). If the keyword does not already exist in the keyword database 114, then, in step 310, the processing server 102 may add the generated keyword to the keyword database 114 (e.g., and store the allocation of the keyword to the corresponding product or products). In one embodiment, if the keyword already exists in the database, but is allocated to a different good or service, then a different iteration of the keyword allocated to the current good or service may be added to the keyword database 114.

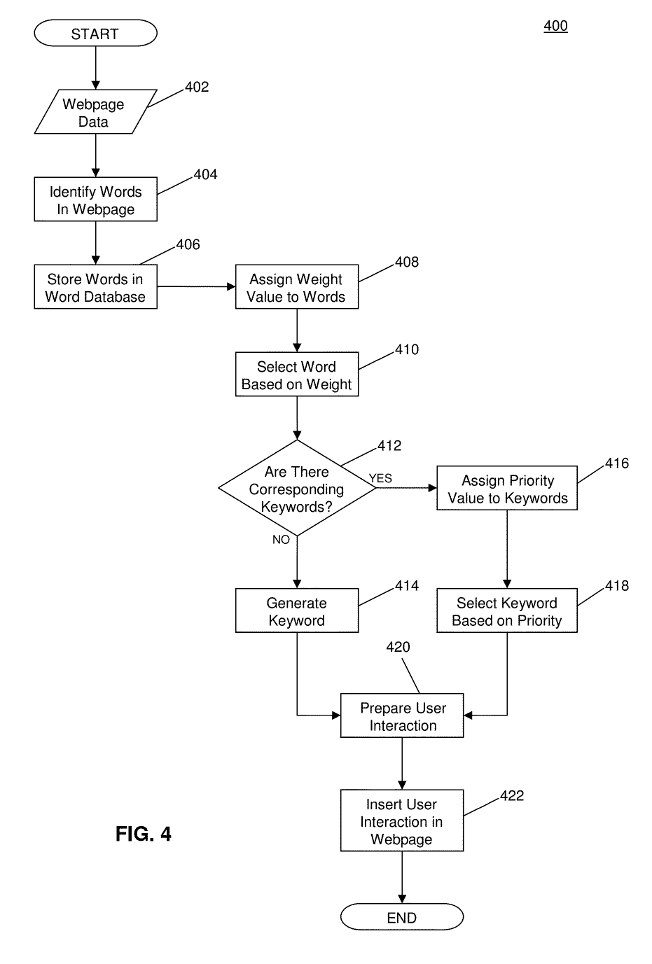

In step 312, the processing server 102 may receive a request for an advertisement. The request may be from the publisher 106, from within the processing server 102 (e.g., as part of the method illustrated in FIG. 4), or a third party. The request for an advertisement may include a webpage, a content area of a webpage, a specific keyword, a set of keywords, or any other type of request as will be apparent to persons having skill in the relevant art. In step 314, the processing server 102 may identify keywords (e.g., stored in the keyword database 114) associated with the advertisement request. In some instances, only a single keyword may be identified (e.g., if the request for an advertisement provided a single keyword). In other instances, a plurality of keywords may be identified. The plurality of keywords may include a plurality of unique keywords (e.g., keywords “phone,” “smart phone,” and “iPhone®”) or the plurality of keywords may include multiple iterations of a keyword, each iteration associated with a different product (e.g., keyword “phone” as associated with an iPhone® 3, and keyword “phone” as associated with an iPhone® 4).

In step 316, as another part of the technical solution, priority values may be assigned by the processing server 102 to each keyword in the plurality of identified keywords. The priority value may be based on the keyword's conversion rate (e.g., rate at which a user interaction will result in a purchase of the corresponding advertised good or service), brand weight (e.g., if the keyword is a brand name), commission value, click through rate (e.g., rate at which a user will interact with the corresponding advertisement), historic basket value, etc. The priority value of a keyword may also be based on hitwise data (e.g., the search frequency of the keyword), site traffic data (e.g., the performance of the keyword on the website in which the advertisement will be displayed), financial data (e.g., market share, recent sales history, historic sales history, etc.), or any other consideration as will be apparent to persons having skill in the relevant art. In some embodiments, the priority value may be based on the location of the keyword on the webpage, the context of the webpage, the subject of the webpage, the title of the webpage, or the title of the website on which the webpage is hosted.

The priority value for a keyword may also be based on available information related to the user 104, such as demographic information (e.g., age, gender, income, relationship status, familial status, residential status, education, occupation, etc.), social information (e.g., likes or dislikes of the user 104 or of socially-networked friends of the user 104, information provided through Facebook®, Twitter®, or other social networking services, etc.), historical information of the user 104 (e.g., past click through history, past conversions, previously owned products, currently owned products, browsing history, search history, etc.), or any other type of information suitable as will be apparent to persons having skill in the relevant art.

Once priority values have been established for each keyword, in step 318, the processing server 102 may select at least one keyword based on the assigned priority values (e.g., selecting the keyword(s) with the highest priority). In some instances, only a single keyword may be selected. In other instances, multiple keywords may be selected (e.g., for displaying multiple advertisements on a single webpage, for displaying multiple advertisements across a website, etc.). In step 320, the processing server 102 may identify products (e.g., goods or services) associated with the selected at least one keyword. Products (e.g., stored in the product database 112) may be identified based on the keyword allocations generated in step 306. In one embodiment, if each keyword is allocated a single product (e.g., if there are multiple iterations of a specific keyword), then only a single product may be identified.

If multiple products are identified, then, in step 322, the processing server 102 may assign priority values to each identified product associated with the at least one keyword. Priority values for each product may be based on similar characteristics as the priority values assigned to keywords, including demographic information of the user 104, historical information of the product, financial information, conversion rate, click through rate, hitwise data, etc. The priority value for a product may also include the subject of the webpage in which the advertisement may appear, the context of use of the corresponding keyword, the title of the webpage, the title of the website, the subject of the website, website metadata, and other considerations as will be apparent to persons having skill in the relevant art. In step 324, the processing server 102 may select a product (e.g., good or service) based on the assigned priority values to each product associated with the at least one keyword.

In step 326, the processing server 102 may prepare the product data associated with the product (e.g., and stored in the database 112). In some embodiments, preparing the product data may include preparing an advertisement for the associated good or service. Manners and methods of preparing the product data will be apparent to persons having skill in the relevant art, and may be dependent on instructions received in the advertisement request, or may be dependent on the webpage or website in which the advertisement will be displayed.

The processing server 102 may also, in step 328, prepare a user interaction for the at least one keyword, such that when a user (e.g., the user 104) interacts with the at least one keyword, an advertisement for the selected product will be displayed. Suitable user interactions may include the user 104 clicking on the keyword, the user double-clicking on the keyword, or the user 104 highlighting the keyword. In an exemplary embodiment, the user interaction may be the user 104 hovering a cursor over the keyword. Methods of displaying the advertisement may include displaying the advertisement in an overlaid window, in a new window, in a new tab, in a predetermined area on the webpage, or any other method of displaying an advertisement on a webpage that will be apparent to persons having skill in the relevant art.

In step 330, the processing server 102 (e.g., by using the I/O device 206) may transmit the prepared user interaction in a reply to the request for advertisement (e.g., to another process in the processing server 102, to the publisher 106, etc.).

### Method for Displaying Advertisements

FIG. 4 illustrates a method 400 for displaying an advertisement on a webpage, the advertisement being based on prioritized keywords and weighted words.

In step 402, a processing server (e.g., the processing server 102) may receive (e.g., via the network 110) webpage data. The webpage data may be from a web server, from the publisher 106, or from a third party. The webpage data may include any data necessary for performing the functions as disclosed herein, such as files, code, metadata, images, or any other data that will be apparent to persons having skill in the relevant art. In step 404, the processing server may 102 may analyze the webpage data to identify a plurality of words displayed by the webpage. Methods of identifying words will be apparent to persons having skill in the relevant art. Identified words may be single words or multiple words (e.g., that form a phrase).

In step 406, the processing server 102 may store the identified plurality of words in a database (e.g., the word database 116). A weight value may be assigned to each of the words in the plurality of words, in step 408, by the processing server 102. The weight value for each word may be based on contextual data, such as the location of the word on the webpage, the subject of the webpage, the context of the use of the word, the title of the webpage, the title of the website, the subject of the website, the author of the webpage, webpage metadata, etc. The weight value may also be based on demographic data of the website or of a particular user (e.g., the user 104) if the advertisement is being prepared and displayed in real-time for each specific user. Demographic data that may be suitable for weighting words may include, without limitation, user age, income, gender, familial status, marital status, residential status, geographic location, education, occupation, etc. Other user information may be used for weight determination, if available, such as user browsing history, purchasing history, social network information (e.g., of the user 104 or of socially-networked friends, family, acquaintances, etc.), or user-provided information. The weight value may also be based on hitwise or site traffic data, such as words which most often bring a user to the particular webpage. Other data that may be relevant for the determination of a weight value for words will be apparent to persons having skill in the relevant art.

In step 410, the processing server 102 may select a word of the plurality of words based on the assigned weight value (e.g., the word with the highest weight value). In step 412, the processing server 102 may search a database (e.g., the keyword database 114) to determine if there are any keywords corresponding to the selected word. If there are no existing keywords, then, in step 414, the processing server 102 may generate a keyword based on the selected word (e.g., and store the generated keyword in the keyword database 114).

If corresponding keywords exist, then the processing server 102 may proceed to step 416. If only a single corresponding keyword exists, then this step may not need be performed. In instances where multiple keywords exist (e.g., multiple iterations of a keyword with each corresponding to a different product), the processing server 102 may assign priority values to each keyword. Priority values for the keywords may be based on any of the considerations disclosed herein, as discussed above with respect to the method 300. In step 418, the processing server 102 may select at least one keyword based on the assigned priority values.

In step 420, the processing server 102 may prepare a user interaction (e.g., based on the generated keyword in step 414 or the selected at least one keyword in step 418). The user interaction may be a modification of the selected word as displayed by the webpage such that when a user (e.g., the user 104) interacts with the word, an advertisement for the product associated with the keyword is displayed. Suitable user interactions may include the user 104 clicking on the keyword, the user double-clicking on the keyword, or the user 104 highlighting the keyword. In an exemplary embodiment, the user interaction may be the user 104 hovering a cursor over the keyword. Methods of displaying the advertisement may include displaying the advertisement in an overlaid window, in a new window, in a new tab, in a predetermined area on the webpage, or any other method of displaying an advertisement on a webpage that will be apparent to persons having skill in the relevant art.

In step 422, the processing server 102 may insert the user interaction into the webpage. The user interaction may be inserted by replacing the associated word in the code for the webpage with code containing the user interaction. Other methods of inserting the user interaction will be apparent to persons having skill in the relevant art. In some embodiments, the processing server 102 may also transmit the webpage including the user interaction, or the user interaction itself, to a third party, such as the publisher 106 or a web server hosting the webpage.

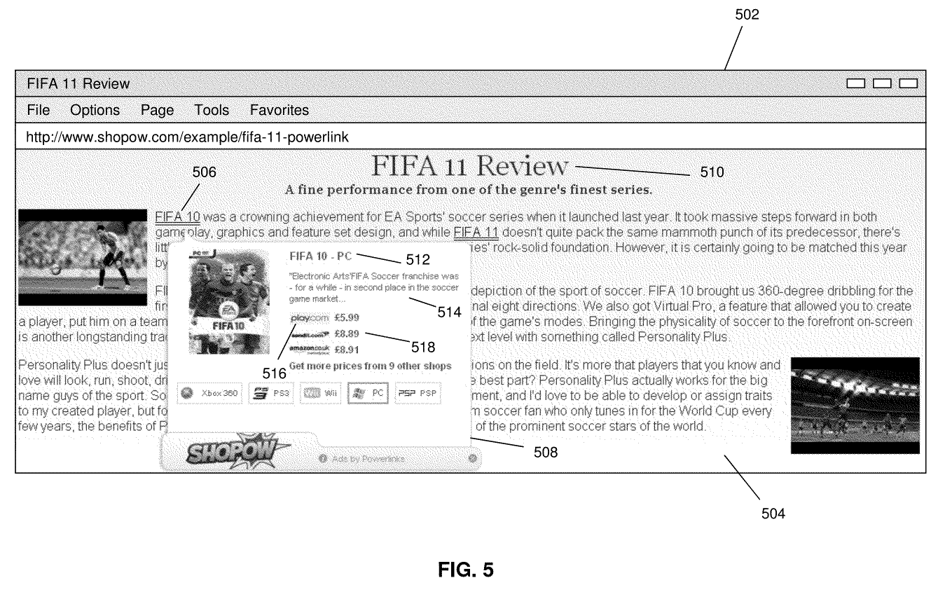

FIG. 5 is a graphical illustration of an advertisement displayed upon a user interaction in accordance with the method 400. A browser window 502 (e.g., on a personal computer or other display device, such as a display device operated by the user 104) may display a webpage 504. The webpage 504 may include a plurality of words. At least one word of the plurality of words may be programmed (e.g., coded) to display an advertisement when interacted with by a the user 104, such as word 506 displayed by the webpage 504. The word 506 may have been selected, for example, as being related to a title of the webpage 510. The user 104 may move a cursor over the word 506, which may then display an advertisement 508. The advertisement 508 may have been selected based on its relation to the title of the webpage 510, or the word 506, for example.

As illustrated in FIG. 5, the advertisement 508 may be configured to display product data (e.g., stored in the product database 112). For example, the advertisement 508 may include the name of the product 512 and a description of the product 514. In some embodiments, the advertisement 508 may include a purchase address (e.g., a hyperlink to a website where the product may be purchased) such as the purchase address 516. In a further embodiment, the advertisement 508 may also include a purchase price 518, which in some instances may be associated with the purchase address. In some embodiments, the advertisement 508 may include multiple purchase addresses and accompanying purchase prices.

### Exemplary Method for Displaying an Advertisement

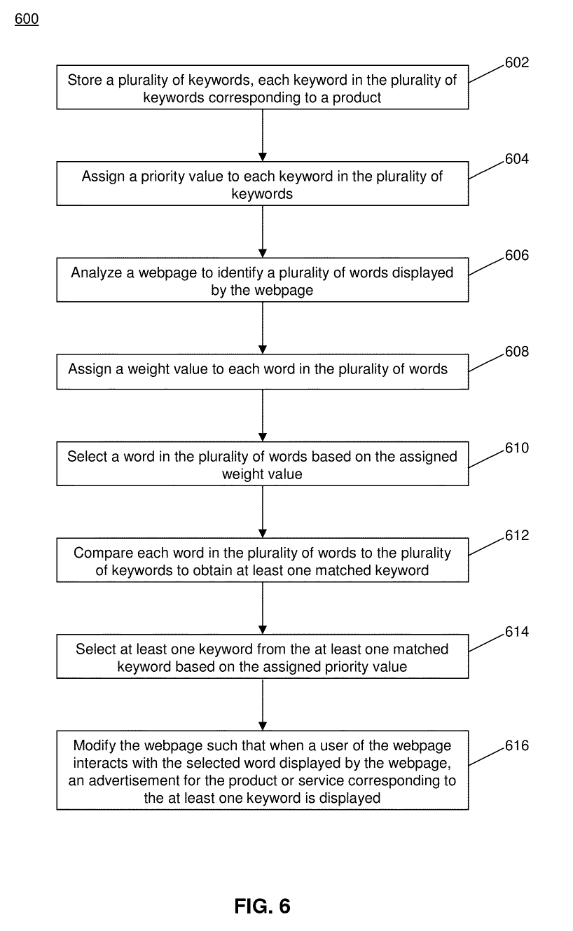

FIG. 6 illustrates a method 600 for displaying an advertisement. In step 602, a processing server (e.g., the processing server 102) may store a plurality of keywords (e.g., in the keyword database 114), each keyword in the plurality of keywords corresponding to a product (e.g., stored in the product database 112). In one embodiment, each keyword may be a single word or may be a phrase consisting of multiple words. In one embodiment, each keyword in the plurality of keywords may correspond to a unique product (e.g., the corresponding product data is unique compared to all other stored product data).

In step 604, the processing server 102 may assign a priority value to each keyword in the plurality of keywords. In one embodiment, the priority value may be based on conversion rate, brand weight, commission value, click through rate, or historic basket value. In another embodiment, the priority value may be based on properties of the user (e.g., demographic information, social information, historical information, etc.). In other embodiments, the priority value may be based on other considerations as disclosed herein and discussed above.

In step 606, the processing server 102 may analyze a webpage to identify a plurality of words displayed by the webpage. The processing server 102, in step 608, may assign a weight value to each word in the plurality of words. In one embodiment, the weight value may be based on conversion rate, brand weight, commission value, click through rate, or historic basket value. In another embodiment, the priority value may be based on properties of the user (e.g., demographic information, social information, historical information, etc.). In other embodiments, the priority value may be based on other considerations as disclosed herein and discussed above. In an exemplary embodiment, each word and the assigned weight value may be stored in a database (e.g., the word database 116).

In step 610, the processing server 102 may select a word in the plurality of words based on the assigned weight value. In one embodiment, the selected word may have the highest weight value of all words in the plurality of words. In step 612, the processing server 102 may compare the selected word to the plurality of keywords to obtain at least one matched keyword. In one embodiment, the at least one matched keyword may be the same as the selected word. In another embodiment, the at least one matched keyword may be a synonym of the selected word. In yet another embodiment, the at least one matched keyword may be related to the selected word.

In step 614, the processing server 102 may select at least one keyword from the at least one matched keyword based on the assigned priority value. In one embodiment, the selected at least one keyword may have the highest priority value of all of the matched keywords. In step 616, the processing server 102 may modify the webpage such that when a user of the webpage (e.g., the user 104) interacts with the selected word displayed by the webpage, an advertisement (e.g., the advertisement 508) for the product or service corresponding to the at least one keyword is displayed. In one embodiment, the user interaction may include when the user moves a cursor over the selected word.

### Exemplary Method for Distributing Advertisements

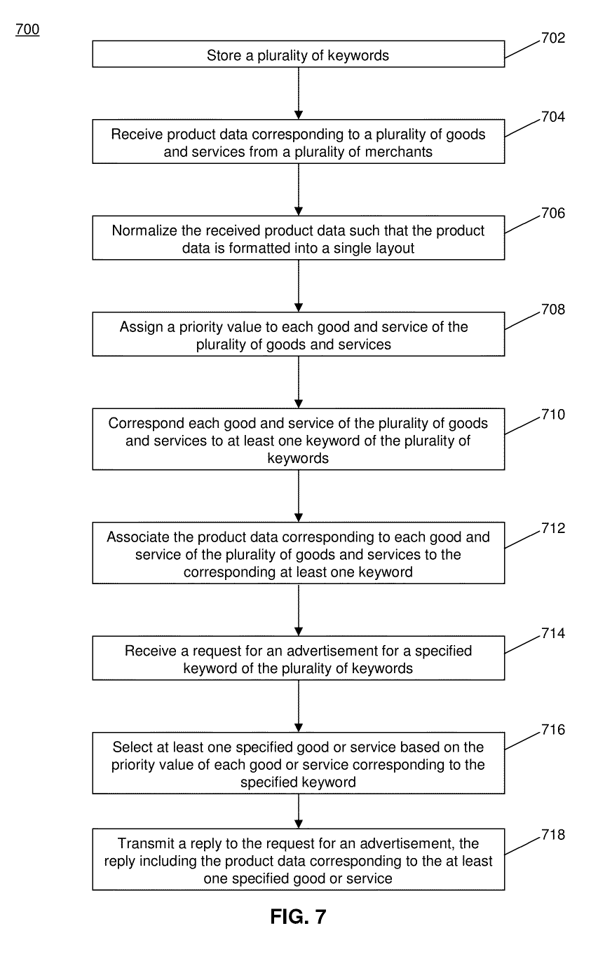

FIG. 7 illustrates an exemplary method 700 for distributing advertisements.

In step 702, a processing server (e.g., the processing server 102) may store a plurality of keywords (e.g., in the keyword database 114). In one embodiment, the plurality of keywords may include keywords generated by analyzing a plurality of webpages. In another embodiment, the plurality of keywords may include keywords generated by analyzing product data. In step 704, the processing server 102 may receive product data corresponding to a plurality of goods and services from a plurality of merchants. In one embodiment, the product data may be stored in a product database (e.g., the product database 112). In one embodiment, the product data may include at least one of merchant name, product name, product description, product price, purchase address, brand name, product color, universal product code (UPC), European article number (EAN), manufacturer part number (MPN), or international standard book number (ISBN). The processing server 102 may normalize the received product data, in step 706, such that the product data is formatted into a single layout.

In step 708, the processing server 102 may assign a priority value to each good and service of the plurality of goods and services. In one embodiment, the priority value may be based on at least one of conversion rate, brand weight, commission value, click through rate, or historic basket value. In another embodiment, the priority value may be based on properties of a consumer. In step 710, the processing server 102 may correspond each good and service of the plurality of goods and services to at least one keyword of the plurality of keywords. In one embodiment, the correspondence information may be stored in a database (e.g., the keyword database 114 or the product database 112).

In step 712, the processing server 102 may associate the product data corresponding to each good and service of the plurality of goods and services to the corresponding at least one keyword. In one embodiment, the association information may be stored in a database (e.g., the product database 112 or the keyword database 114). The processing server 102 may, in step 714, receive a request for an advertisement for a specified keyword of the plurality of keywords. In one embodiment, the request for an advertisement may originate from a publisher (e.g., the publisher 106) or a third party (e.g., on behalf of the publisher 106). In another embodiment, the request for an advertisement may originate from the processing server 102 (e.g., after analyzing a webpage and identifying a word for the display of an advertisement).

In step 716, the processing server 102 may select at least one specified good or service based on the priority value of each good or service corresponding to the specified keyword. In one embodiment, the good or service with the highest priority value may be selected. In step 718, the processing server 102 may transmit a reply to the request for an advertisement, the reply including the product data corresponding to the at least one specified good or service. In one embodiment, the including product data may include only a subset of the corresponding product data. In a further embodiment, the subset of the corresponding product data may include at least one of product name, product description, product price, merchant name, purchase address, and product quantity.

Where methods described above indicate certain events occurring in certain orders, the ordering of certain events may be modified. Moreover, while a process depicted as a flowchart, block diagram, etc. may describe the operations of the system in a sequential manner, it should be understood that many of the system's operations can occur concurrently. For example, although the processing server 102 is illustrated in FIG. 4 as assigning weight value to words (step 408) and selecting a word (step 410) prior to assigning priority values to keywords (step 416), the processing server 102 may instead assign priority values to keywords prior to assigning a weight value to words or selecting a word, or may perform each function concurrently.

Techniques consistent with the present disclosure provide, among other features, systems and methods for distributing content to devices, initiating financial transactions, processing electronic financial transactions using a payer device and pay codes, and indirectly controlling websites. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for displaying an advertisement, comprising:
storing, in a keyword database, a plurality of keywords, each keyword in the plurality of keywords corresponding to a product or service;
assigning a priority value to each keyword in the plurality of keywords;
analyzing a webpage to identify a plurality of words displayed by the webpage;
assigning a weight value to each word in the plurality of words;
selecting a word in the plurality of the words based on the assigned weight value;
comparing the selected word to the plurality of keywords to obtain at least one matched keyword;
selecting at least one keyword from the at least one matched keyword based on the assigned priority value; and
modifying the webpage such that when a user of the webpage interacts with the selected word displayed by the webpage, an advertisement for the product or service corresponding to the at least one keyword is displayed.

2. The method of claim 1, wherein the priority value is based on at least one of: conversion rate, brand weight, commission value, click through rate, or historic basket value.

3. The method of claim 1, wherein the weight value is based on at least one of: conversion rate, brand weight, commission value, click through rate, or historic basket value.

4. The method of claim 1, wherein the priority value is based on properties of the user.

5. The method of claim 1, wherein the weight value is based on properties of the user.

6. The method of claim 1, wherein the weight value assigned to each word is based on an assessment of the context of the corresponding word as displayed on the webpage.

7. The method of claim 1, wherein the weight value assigned to each word is based on the position of the word as displayed on the webpage.

8. A system for displaying an advertisement, comprising:
a database configured to store a plurality of keywords, each keyword in the plurality of keywords corresponding to a product or service; and
a processor configured to
assign a priority value to each keyword in the plurality of keywords;
analyze a webpage to identify a plurality of words displayed by the webpage;
assign a weight value to each word in the plurality of words;
select a word in the plurality of words based on the assigned weight value;
compare the selected word to the plurality of keywords to obtain at least one matched keyword;
select a single keyword from the at least one matched keyword based on the assigned priority value; and
modify the webpage such that when a user of the webpage interacts with the selected word displayed by the webpage, an advertisement for the product or service corresponding to the single keyword is displayed.

9. The system of claim 8, wherein the priority value is based on at least one of: conversion rate, brand weight, commission value, click through rate, or historic basket value.

10. The system of claim 8, wherein the weight value is based on at least one of: conversion rate, brand weight, commission value, click through rate, or historic basket value.

11. The system of claim 8, wherein the priority value is based on properties of the user.

12. The system of claim 8, wherein the weight value is based on properties of the user.

13. The system of claim 8, wherein the weight value assigned to each word is based on an assessment of the context of the corresponding word as displayed on the webpage.

14. The system of claim 8, wherein the weight value assigned to each word is based on the position of the word as displayed on the webpage.

15. A non-transitory computer-readable recording medium having a program stored thereon that causes a processor of a computing device to execute the method of claim 1.

16. A method for distributing advertisements, comprising:
storing, in a database, a plurality of keywords;
receiving product data corresponding to a plurality of goods and services from a plurality of advertisers;
normalizing, by a computer, the received product data, such that the product data is formatted into a single layout;
assigning a priority value to each good and service of the plurality of goods and services;
corresponding each good and service of the plurality of goods and services to at least one keyword of the plurality of keywords;
associating, in the database, the product data corresponding to each good and service of the plurality of goods and services to the corresponding at least one keyword;
receiving a request for an advertisement for a specified keyword of the plurality of keywords;
selecting at least one specified good or service based on the priority value of each good or service corresponding to the specified keyword; and
transmitting a reply to the request for an advertisement, the reply including the product data corresponding to the at least one specified good or service.

17. The method of claim 16, wherein the priority value is based on at least one of: conversion rate, brand weight, commission value, click through rate, or historic basket value.

18. The method of claim 16, wherein the product data includes at least one of: merchant name, product name, product description, product price, a purchase address, brand name, product color, universal product code, manufacturer part number, European article number, or international standard book number.

19. A system for distributing advertisements comprising:
a database configured to store data including a plurality of keywords;
a receiving device configured to receive product data corresponding to a plurality of goods and services from a plurality of advertisers and a request for an advertisement for a specified keyword of the plurality of keywords;
a processor configured to
normalize the received product data such that the product data is formatted into a single layout;
assign a priority value to each good and service of the plurality of goods and services;
correspond each good and service of the plurality of goods and services to at least one keyword of the plurality of keywords; and
select at least one specified good or service based on the priority value of each good or service corresponding to the specified keyword; and
a transmitting device configured to transmit a reply to the request for an advertisement, the reply including the product data corresponding to the at least one specified good or service.

20. The system of claim 19, wherein the priority value is based on at least one of: conversion rate, brand weight, commission value, click through rate, or historic basket value.

21. The system of claim 19, wherein the product data includes at least one of: merchant name, product name, product description, product price, a purchase address, brand name, product color, universal product code, manufacturer part number, European article number, or international standard book number.

22. A non-transitory computer-readable recording medium having a program stored thereon that causes a processor of a computing device to execute the method of claim 16.
